(19) United States
(12) Patent Application Publication
(10) Pub. No.: US 2006/0067547 A1
(43) Pub. Date: Mar. 30, 2006

(54) Stereo portable electronic device

(76) Inventors: Minh Le, Neuilly Sur Seine (FR); Laurent Vermeglio, Suresnes (FR)

Correspondence Address: Joseph Sofer;SOFER & HAROUN, LLP, Suite 910, 317 Madison Avenue, New York, NY, 10017, US

(21) Appl. No.: 11/199,574

(22) Filed: Aug. 8, 2005

(30) Foreign Application Priority Data
Aug. 25, 2004 (FR) 04 51 903

(51) Int. Cl. H04R 5/02; H04R 1/02

(52) U.S. Cl. 381/300; 381/304; 381/334

(57) ABSTRACT

A portable electronic device comprises a first flap extending longitudinally along a first axis, a second flap, a first audiophonic portion and a second audiophonic portion having the same function as the first audiophonic portion. The audiophonic portions are disposed so that their orthogonal projections on the first axis are separate to produce a stereo effect in the direction of the first axis when the device is positioned horizontally and parallel to the direction of the first axis. The orthogonal projections of the audiophonic portions on a second axis substantially perpendicular to the first axis are also separate to produce a stereo effect in the direction of the second axis when the device is positioned vertically and parallel to the direction of the first axis.

### RELATED APPLICATION

This application is related to and claims the benefit of priority from French Patent Application No. 04 51 903, filed on Aug. 25, 2004, the entirety of which is incorporated herein by reference.

### BACKGROUND OF THE INVENTION

1. Field of the Invention

The present invention relates to stereo portable electronic devices.

2. Description of the Prior Art

Portable electronic devices, classically a mobile telephone terminal, are widely used nowadays. Personal digital assistants (PDA), MP3 players and portable games consoles constitute other examples of portable electronic devices.

Portable electronic devices may comprise one or more units. Portable electronic devices comprise a first flap and a second flap, which may or may not be separate.

When the first flap and the second flap are combined, the portable electronic device consists of a single unit.

When the first flap and the second flap are separate, the second flap is generally mobile relative to the first flap between an open configuration and a closed configuration. Intermediate configurations may also be adopted. Examples that may be cited include clamshell, swivel and slider type portable electronic devices.

Portable electronic devices generally comprise a handsfree loudspeaker used in a “handsfree” operating mode and a separate loudspeaker used in a “discreet” operating mode. In the case of a mobile telephone terminal, the handsfree loudspeaker is used to indicate a call by means of an audible notification, for example, typically a ringer. If the user is at a relatively large distance from the mobile telephone terminal, for example 50 centimeters, the handsfree loudspeaker is also used to convert into an acoustic signal an electrical signal corresponding to the speech of another person on the telephone addressed to a user of the portable electronic device. When the terminal is close to an ear of the user, the discreet loudspeaker converts into a low-power acoustic signal the electrical signal corresponding to the words that the other person on the telephone is addressing to the user of the portable electronic device.

The handsfree loudspeaker and the discreet loudspeaker may be one and the same, but are usually separate, the handsfree loudspeaker generally emitting sounds at a higher power than the discreet loudspeaker.

Portable electronic devices can also comprise a handsfree microphone and a discreet microphone. For example, in the case of a mobile telephone terminal, the handsfree microphone converts into an electrical signal an acoustical signal corresponding to the words that the user addresses to the other person on the telephone when the user is at a relatively large distance from the mobile telephone terminal. The discreet microphone is used when the terminal is close to the user's mouth.

Portable electronic devices can also comprise two handsfree loudspeakers and/or two handsfree microphones.

If the portable electronic device comprises two handsfree loudspeakers, it conventionally comprises two separate reproduction channels, each reproduction channel being connected to one of the handsfree loudspeakers. Each reproduction channel carries an appropriate electrical signal so that the user listening to the sound reproduced by the two handsfree loudspeakers obtains the benefit of a stereo effect, according to the relative positions of the handsfree loudspeakers and his ears.

Similarly, if the mobile telephone device comprises two handsfree microphones, each handsfree microphone may be connected to a specific reproduction channel to produce a stereo effect.

British patent application GB 2 372 666 describes a mobile telephone terminal comprising first and second transducers. The transducers have the same function; in other words, the two transducers may be either two loudspeakers or two microphones. The mobile telephone terminal comprises a first flap and a second flap. The second flap is mobile relative to the first flap between an open configuration and a closed configuration to form a clamshell type mobile telephone terminal. The first flap extends longitudinally along a first axis. The transducers are disposed so that their orthogonal projections in the plane of the first flap are on the first axis. The first loudspeaker and the second loudspeaker are respectively situated on the first flap and the second flap, opposite each other.

A mobile telephone terminal of the above kind provides a stereo effect in the direction of the first axis, thus in particular when the mobile telephone terminal is in a “landscape” position, that is to say when the first axis is horizontal. The landscape position is used, for example, if the user wishes to listen to music reproduced by the mobile telephone terminal and therefore places it on a table.

On the other hand, when the terminal is in a vertical or “portrait” position, the loudspeakers are then situated on substantially the same vertical axis relative to the user, which eliminates the stereo effect. The portrait position may also be used frequently, for example when the user is holding the mobile telephone terminal substantially vertical in one hand.

The present invention enables a stereo effect to be produced both in the landscape position and in the portrait position.

### SUMMARY OF THE INVENTION

The present invention provides a portable electronic device comprising a first flap extending longitudinally along a first axis, a second flap, a first audiophonic portion and a second audiophonic portion having the same function as the first audiophonic portion, the audiophonic portions being disposed so that their orthogonal projections on the first axis are separate to produce a stereo effect in the direction of the first axis when the device is positioned horizontally and parallel to the direction of the first axis, the orthogonal projections of the audiophonic portions on a second axis substantially perpendicular to the first axis being also separate to produce a stereo effect in the direction of the second axis when the device is positioned vertically and parallel to the direction of the first axis.

The expression “audiophonic portions having the same function” embraces in particular either two handsfree loudspeakers operating simultaneously to produce a stereo effect or two microphones also operating simultaneously to capture the voice of the user of the device in stereo.

As the orthogonal projections of the audiophonic portions are separate both on the first axis and on the second axis, the portable electronic device of the present invention produces a stereo effect both in the portrait position and in the landscape position.

For example, the audiophonic portions may each comprise a transducer and an electronic circuit adapted to transmit and/or to receive electrical signals corresponding to acoustic signals.

The portable electronic device may equally comprise more than two audiophonic portions. For example, the portable electronic device of the present invention may comprise a first audiophonic portion comprising a first handsfree loudspeaker, a second audiophonic portion comprising a second handsfree loudspeaker, and a supplementary audiophonic portion comprising an additional handsfree loudspeaker adapted to serve as a bass speaker.

The audiophonic portions have the same function: for example, the audiophonic portions preferably each comprise a handsfree loudspeaker. The first audiophonic portion advantageously comprises a first handsfree loudspeaker and the second audiophonic portion advantageously comprises a second handsfree loudspeaker. The portable electronic device therefore offers the facility of hearing or listening to sounds in stereo.

Each audiophonic portion may alternatively comprise a handsfree microphone. The first audiophonic portion may comprise a first handsfree microphone and the second audiophonic portion may comprise a second handsfree microphone. Thus the portable electronic device can offer the possibility of recording or transmitting sounds in stereo, for example.

Alternatively, the audiophonic portions may each comprise a handsfree loudspeaker and a handsfree microphone. Thus the portable electronic device provides a stereo effect both on reception and on transmission.

Thus the present invention is not limited by the function of the audiophonic portions, i.e. combinations of the embodiments described hereinafter with audiophonic portions each comprising a handsfree microphone are also part of the present invention.

The first handsfree loudspeaker and the second handsfree loudspeaker are advantageously disposed so that their projections in the plane of the first flap are substantially on a diagonal of the projection of the portable electronic device in the plane of the first flap. The first handsfree loudspeaker and the second handsfree loudspeaker are advantageously opposite each other.

For example, the first handsfree loudspeaker is disposed in a top left corner of the portable electronic device and the second handsfree loudspeaker is disposed in a bottom right corner. The second axis is advantageously substantially equidistant from first and second ends of the portable electronic device and defines the top and the bottom of the portable electronic device. The first axis also divides the portable electronic device into a right-hand portion and a left-hand portion of substantially the same size.

The handsfree loudspeakers disposed in this way along a diagonal of the portable electronic device and opposite each other are therefore situated at a relatively great distance from each other.

In particular, the distance between the orthogonal projections on the first axis of the first and second handsfree loudspeakers is relatively large, thereby guaranteeing a good stereo effect in the landscape position. Similarly, the distance between the orthogonal projections on the second axis of the first and second handsfree loudspeakers is also relatively large, thereby guaranteeing a good stereo effect in the portrait position.

The present invention is not, however, limited by a position of the handsfree loudspeakers or at least of their projections in the plane of the first flap, relative to one of the diagonal axes of the portable electronic device, or at least of the projection in the plane of the first flap of the portable electronic device.

The first flap is generally, at least broadly speaking, three dimensional: having a length, in the direction of the first axis, a width, typically in the direction of the second axis, and a thickness. The orthogonal projections of the handsfree loudspeakers onto a third axis in the direction of the thickness may also be separate, thereby guaranteeing a stereo effect when the portable electronic device is seen from the side.

Neither is the present invention limited by the orientation of the handsfree loudspeakers.

The first handsfree loudspeaker is advantageously integrated into the first flap and the second handsfree loudspeaker is advantageously integrated into the second flap. The second flap is advantageously mobile relative to the first flap between a first configuration and at least one second configuration, the first configuration being that in which the orthogonal projections of the handsfree loudspeakers on the first axis are separate.

Thus a portable electronic device of the above kind is able to adopt a plurality of configurations, which makes it more practical to use. Conventionally, but not in a manner that is limiting on the invention, the first configuration is an open configuration and the second configuration is a closed configuration that is more compact than the open configuration. The user selects the configuration of the portable electronic device according to the intended use: for example, if the user wishes to carry the portable electronic device in a garment pocket, he will opt for the closed configuration.

The first and second handsfree loudspeakers are integrated into separate flaps, so that it is possible to modify the distance between the handsfree loudspeakers with the kinematic of the portable electronic device.

Alternatively, both handsfree loudspeakers are on the same flap of the portable electronic device.

Alternatively, the first flap and the second flap may be one and the same: the portable electronic device is then in one piece and can therefore adopt only one configuration, in which the portable electronic device extends along the first axis between the first and second ends. A portable electronic device of this kind can of course produce a stereo effect both in the portrait position and in the landscape position.

The portable electronic device advantageously comprises at least one hinge extending along a hinge axis substantially parallel to the second axis. The hinge connects the first flap to the second flap. The hinge articulates the second flap about the hinge axis.

A clamshell type portable electronic device of this kind is able to assume a closed configuration in which the first flap and the second flap are folded one against the other. In the closed configuration, most of the components of a user interface, typically a screen and keys of a keypad, are protected.

If the handsfree loudspeakers are disposed on a diagonal and opposite each other, the stereo effect is good when the portable electronic device is open in the landscape or portrait position, of course. Moreover, in the closed configuration, when the flaps are folded one against the other, the distance between the orthogonal projections on the second axis of the first and second handsfree loudspeakers remains relatively large, still guaranteeing a good stereo effect when the portable electronic device is in the portrait position.

For example, in the case of a mobile telephone terminal in the closed configuration and carried in the portrait position in the user's pocket, the relative position of the handsfree loudspeakers relative to the ears of the user produces a good stereo effect from a ringer, if there is one. The user can improve the stereo effect, for example to listen to music, by opening the mobile telephone terminal and placing it in the landscape position.

Alternatively, the portable electronic device of the present invention may comprise a pivot allowing the second flap to swivel about a rotation axis substantially perpendicular to the first flap.

A portable electronic device of this swivel type can assume a closed configuration in which the first flap and the second flap are one above the other and in which an external face of the second flap may comprise at least some of the units of the user interface. In the conventional way, the screen of the user interface remains visible in the closed configuration whereas the keys of the keypad are protected.

If the handsfree loudspeakers are disposed on a diagonal and opposite each other when the portable electronic device is in the open configuration, the stereo effect is of course good when the portable electronic device is in the open configuration, whether in the landscape or portrait position.

Alternatively, the first configuration of the swivel type portable electronic device may be a half-open configuration, so that a longitudinal direction of the second flap is substantially perpendicular to the first axis. The handsfree loudspeakers may be disposed top right on the second flap and bottom right on the first flap when the portable electronic device is in the open configuration, for example. In the half-open configuration, the orthogonal projections of the handsfree loudspeakers on the first axis are then separate and the orthogonal projections of the handsfree loudspeakers on the second axis are also separate. This portable electronic device produces a stereo effect in the half-open configuration, whether in the portrait or landscape position. In the closed configuration, the orthogonal projections of the handsfree loudspeakers on the second axis remain separate, producing a stereo effect in the portrait position. In the open configuration, the orthogonal projections of the handsfree loudspeakers on the first axis remain separate, thereby producing a stereo effect in the landscape position.

Alternatively, the portable electronic device may comprise a support allowing movement of the second flap in translation substantially in the direction of the first axis.

A portable electronic device of this sliding or slider type can also adopt a closed configuration in which the first flap and the second flap are one on top of the other and the external face of the second flap may comprise at least some of the units of the user interface. In the conventional way the screen of the user interface remains visible in the closed configuration whereas the keys are protected.

If the handsfree loudspeakers are disposed on a diagonal and opposite each other, the stereo effect is good when the portable electronic device is in the open configuration, of course, whether in the landscape or portrait position. In the closed configuration, the handsfree loudspeakers are close together, but a stereo effect is still produced, both in the portrait and landscape positions.

For example, the handsfree loudspeakers may be disposed bottom right on the first flap and bottom left on the second flap. In the open configuration, the orthogonal projections of the handsfree loudspeakers on the first axis are separate. The orthogonal projections of the handsfree loudspeakers on the second axis are also separate, with the result that a stereo effect is obtained both in the portrait position and in the landscape position. In the closed configuration, the projections of the handsfree loudspeakers on the second axis are still separate, thereby obtaining a stereo effect in the portrait position.

Of course, the present invention is not limited by the possible movements of the second flap relative to the first flap.

The portable electronic device advantageously comprises a mobile telephone terminal.

The invention is not limited to the nature of the portable electronic device, however. For example, the portable electronic device may comprise a personal digital assistant (PDA), an MP3 player or a portable games console.

The invention is described in more detail hereinafter with reference to drawings representing a preferred embodiment of the invention.

### BRIEF DESCRIPTION OF THE DRAWINGS

FIG. 1A shows a preferred embodiment of a portable electronic device of the present invention in a closed configuration and a portrait position,

FIG. 1B shows a preferred embodiment of a portable electronic device of the present invention in an open configuration and a portrait position,

FIG. 1C shows a preferred embodiment of a portable electronic device of the present invention in an open configuration and a landscape position.

### DETAILED DESCRIPTION OF THE PREFERRED EMBODIMENT

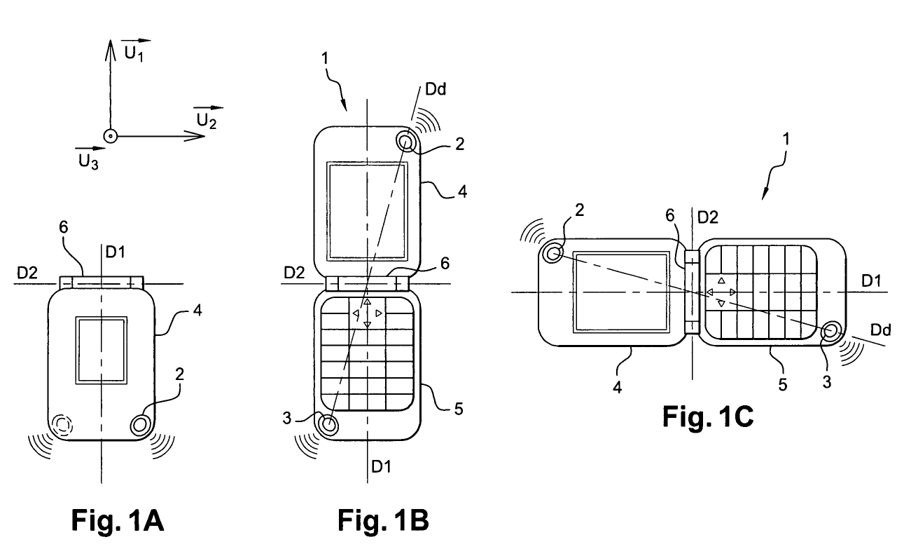

It will be noted that identical or similar components or parts have been designated by the same reference signs in FIGS. 1A, 1B and 1C.

Moreover, in each of FIGS. 1A, 1B and 1C the portable electronic device is described relative to an orthonomic system of axes (\vec{u}₁, \vec{u}₂, \vec{u}₃) The portable electronic device is three-dimensional, the thickness of a first flap 5 of the portable electronic device being in the direction of the vector \vec{u}₃.

In the preferred embodiment of the present invention, the portable electronic device comprises a clamshell type mobile telephone terminal 1 which comprises the aforementioned first flap 5 and a second flap 4. A hinge 6 extends along a hinge axis and articulates the second flap 4 about a hinge axis. The clamshell type mobile telephone terminal 1 can therefore adopt an open configuration represented in FIGS. 1B and 1C or a closed configuration represented in FIG. 1A.

The first flap 5 extends longitudinally along a first axis D1.

The mobile telephone terminal comprises a first handsfree loudspeaker 3 and a second handsfree loudspeaker 2. Both loudspeakers are intended to reproduce sounds simultaneously to produce a stereophonic effect.

The handsfree loudspeakers 2 and 3 are disposed so that their orthogonal projections on the first axis D1 are separate in the open configuration. In the preferred embodiment, the handsfree loudspeakers 2 and 3 are in fact on the separate flaps 4 and 5.

A second axis D2 is substantially perpendicular to the first axis D1. In FIGS. 1A, 1B and 1C the axis D2 coincides with the hinge axis.

Moreover, the orthogonal projections on the second axis D2 of the handsfree loudspeakers 2 and 3 are also separate.

Accordingly, in the open configuration, the mobile telephone terminal 1 produces a stereo effect both in the portrait position and in the landscape position. For greater comfort, the handsfree loudspeakers are disposed opposite each other, so that their projections in the plane of the first flap 5 are substantially on a diagonal axis Dd of the projection of the mobile telephone terminal 1 in the plane of the first flap 5. The distances between the orthogonal projections of the handsfree loudspeakers 2 and 3, whether on the first axis D1 or the second axis D2, are therefore relatively large, thereby offering a good stereo effect in the portrait position and in the landscape position.

In a closed configuration, the first flap 5 and the second flap 4 are folded one on the other.

The orthogonal projections of the handsfree loudspeakers 2 and 3 on the second axis D2 remain at the same distance, whether the mobile telephone terminal 1 is in the open or closed configuration. The user observing the mobile telephone terminal 1 in the direction of the vector \vec{u}₃ has the benefit of the stereo effect in the situation shown in FIG. 1A in which the preferred embodiment of the mobile telephone terminal is in the closed configuration and the portrait position.

In a first alternative embodiment, not shown, the handsfree loudspeakers are substantially on the same axis diagonally crossing the same flap of a portable electronic device of the clamshell type, and opposite each other on that same flap. The distance between the orthogonal projections of the handsfree loudspeakers on the first axis is thus reduced, compared to the preferred embodiment. On the other hand, a clamshell type portable electronic device produces a stereo effect even in the closed configuration and the landscape position. As the handsfree loudspeakers are on the same flap, the stereo effect does not vary with the kinematic of the clamshell type portable electronic device.

In a second alternative embodiment, not shown, the first handsfree loudspeaker is integrated into the first flap and the second handsfree loudspeaker into the second flap. The first handsfree loudspeaker is disposed substantially top left on the first flap while the second handsfree loudspeaker is disposed substantially top right on the second flap. A portable electronic device of this type has the same advantages as the portable electronic device of the first alternative embodiment, plus a slightly greater distance between the orthogonal projections of the handsfree loudspeakers on the first axis in the open configuration, thereby producing a slightly improved stereo effect in the open configuration and the landscape position.

There is claimed:

1. A portable electronic device comprising:
a first flap extending longitudinally along a first axis,
a second flap,
a first audiophonic portion and a second audiophonic portion having the same function as said first audiophonic portion, said audiophonic portions being disposed so that their orthogonal projections on said first axis are separate to produce a stereo effect in the direction of said first axis when said device is positioned horizontally and parallel to the direction of said first axis, the orthogonal projections of said audiophonic portions on a second axis substantially perpendicular to said first axis being also separate to produce a stereo effect in the direction of said second axis when said device is positioned vertically and parallel to the direction of said first axis.

2. The portable electronic device claimed in claim 1, wherein said first audiophonic portion further comprises a first handsfree loudspeaker and said second audiophonic portion comprises a second handsfree loudspeaker.

3. The portable electronic device claimed in claim 2 wherein said first handsfree loudspeaker and said second handsfree loudspeaker are disposed so that their projections in the plane of said first flap are substantially on a diagonal axis of the projection of said portable electronic device in the plane of said first flap with said first and second handsfree loudspeakers opposite each other.

4. The portable electronic device claimed in claim 1 wherein said first flap and said second flap are one and the same.

5. The portable electronic device claimed in claim 2 wherein said first handsfree loudspeaker is integrated into said first flap and said second handsfree loudspeaker is integrated into said second flap, which is mobile relative to said first flap between a first configuration and one or more second configurations, said orthogonal projections of said handsfree loudspeakers on said first axis being separate in said first configuration.

6. The portable electronic device claimed in claim 5, further comprising a hinge extending along a hinge axis substantially parallel to said second axis, connecting said first flap to said second flap and enabling articulation of said second flap about said hinge axis.

7. The portable electronic device claimed in claim 5, further comprising a pivot enabling said second flap to turn about a rotation axis substantially perpendicular to said first flap.

8. The portable electronic device claimed in claim 5, further comprising a support enabling said second flap to move in translation substantially in the direction of said first axis.

9. The portable electronic device claimed in claim 1, wherein said first audiophonic portion comprises a first microphone and said second audiophonic portion comprises a second microphone.

10. The portable electronic device claimed in claim 1, constituting a mobile telephone terminal.
